(19) United States
(12) Patent Application Publication
(10) Pub. No.: US 2010/0025310 A1
(43) Pub. Date: Feb. 4, 2010

(54) JUG FOR FILTERING LIQUIDS

(76) Inventor: Maurizio Moretto, Vicenza (IT)

Correspondence Address: CASTELLANO PLLC, P.O. Box 1555, Great Falls, VA, 22066, US

(21) Appl. No.: 12/514,966

(22) PCT Filed: Oct. 30, 2007
(86) PCT No.: PCT/EP07/09412

§ 371 Date: May 14, 2009

(30) Foreign Application Priority Data
Nov. 15, 2006 (IT) PD2006A000425

(51) Int. Cl. B01D 35/143; B01D 27/08

(52) U.S. Cl. 210/91

(57) ABSTRACT

“A jug (1) for filtering liquids, which includes
a lid (3),
an aperture (4) provided through the lid (3) for the filling of the jug (1),
a blocking mechanism (5) mounted on the lid (3) at the aperture (4) and displaceable between a first position, in which it closes the aperture, and a second, open position,
actuating means associated with the blocking mechanism (5) for urging it into the first position and allowing its passage into the second position under the action of the flow of liquid admitted into the jug (1) through the aperture (4), and
a counting device (11), on the lid (3), for counting the cycles of opening and/or closure of the blocking means (5) as a result of the admission of liquid into the jug (1).”

### TECHNICAL FIELD

The subject of the invention is a jug for filtering liquids of the type including the characteristics mentioned in the preamble of the main claim.

Preferably, the invention refers to a water filtering jug with replaceable filter cartridge; in such jugs the filtering capacity of the cartridges is subject to exhaustion, and therefore the cartridges must be replaced after a certain number of filtering cycles and/or after a predetermined period of activity of the cartridge.

### TECHNOLOGICAL BACKGROUND

In this field it is known to use jugs provided with a counting device, typically installed on the lid, to indicate the number of filtering cycles carried out since the cartridge was last replaced, in order to determine its remaining life.

The number indicated by the device is increased each time the user opens a closure member arranged on the jug, typically constituted by the entire lid or by a part thereof, this operation being prior to the introduction of the water into the jug.

A principal drawback of this solution lies in the fact that the counting device, in order to be actuated, requires an operation carried out manually by the user, involving the need to use both hands for the operation, one to hold the jug and the other to open the closure member. In addition, there is the possibility that the jug may also be opened accidentally or fortuitously, without this being followed by its filling and therefore the completion of a filtering cycle. This involves on the one hand a major inconvenience for the user, who must use both hands for filling up the jug, and on the other hand a substantial uncertainty as to whether the cartridge is still “good”, with consequent uncertainty as to whether it is time to replace it.

### DESCRIPTION OF THE INVENTION

The problem underlying the present invention is that of providing a jug structurally and functionally designed so as to be devoid of all the drawbacks mentioned with reference to the prior art cited.

This problem is solved by a filter jug produced according to the claims which follow.

### BRIEF DESCRIPTION OF THE DRAWINGS

The characteristics and advantages of the invention will become clearer from the detailed description of some exemplary embodiments thereof, illustrated by way of non-limiting example with reference to the appended drawings, in which:

FIGS. 1 and 2 are two diagrammatic sectional views of a detail of a jug produced according to a first exemplary embodiment of the present invention;

FIGS. 3 and 4 are two diagrammatic sectional views of an alternative embodiment of the detail of FIG. 1.

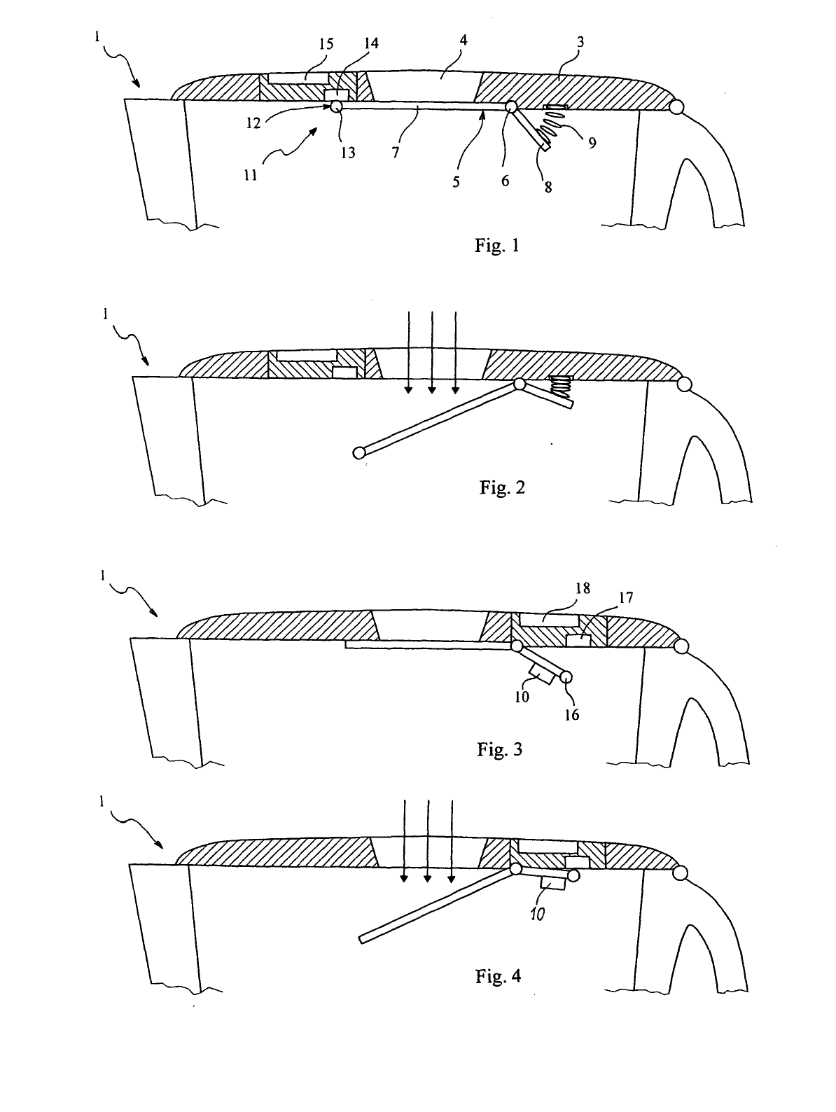

In FIGS. 1 to 4, the reference 1 indicates as a whole a jug for filtering and delivering drinking water. The jug 1 is of the type (known per se) with replaceable filter cartridge.

### PREFERRED EMBODIMENT OF THE INVENTION

The jug comprises a lid 3, on which a through-aperture 4 is provided for the introduction of the water to be filtered.

On the lid 3, at the aperture 4, a blocking mechanism 5 is mounted so as to pivot between a first, closed position in which it closes the aperture 4, as shown in FIGS. 1 and 3, and a second, open position, as shown in FIGS. 2 and 4.

The blocking mechanism 5 is secured to the lid 3 by means of a hinge 6 and comprises, on opposite sides of the axis of the hinge 6, a small blocking plate 7, capable of being moved close to the lid 3 so as to close the aperture 4, and an arm 8 inclined with respect to the plate 7, such that, in the second, open position of the blocking mechanism 5 the plate is brought close to the lid 3.

The lid 3 comprises actuating means associated with said blocking mechanism 5 to urge it towards the first, closed position, and such as to allow it to pass into the second, open position under the action of the flow of liquid admitted into the jug through the aperture 4.

In the exemplary embodiment of FIGS. 1 and 2, the actuating means comprise a helical spring 9, the opposed ends of which are secured, respectively, to the arm 8 and to the lid 3.

In the constructional variant shown in FIGS. 3 and 4, the actuating means comprise a counterweight 10, situated on the arm 8.

The lid 3 comprises a counting device 11 for counting the cycles of opening and closure of the blocking mechanism 5 in order to determine, on the basis of the number of fillings of the jug with water to be filtered, the remaining useful life of the filter cartridge.

The counting device 11 comprises a sensor 12 capable of detecting the passage of the blocking plate 7 from the closed position on the aperture 4 to the open position, or vice versa.

In the exemplary embodiment of FIGS. 1 and 2, the sensor 12 is of the proximity detection type, with a magnet 13, fixed on the opposite end of the plate 7 from the hinge 6, and a magnetic detector 14 fixed in a corresponding position on the lid 3. The magnet 13 and the magnetic detector 14 are close together when the mechanical blocking means 5 is in the first, closed position. Alternatively, provision is made for the sensor to be of the type with electrical contacts 13, 14, such that the relevant circuit is closed when the contacts are bearing on each other and is open when they are distanced from each other. As a further alternative, the sensor 12 may be of the capacitive type, or with immersed electrodes between which the circuit is closed when the level of the water to be filtered admitted into the jug submerges the electrodes by reaching or exceeding a predetermined level, or of the resistance type or some other type known per se, provided that it is suitable for detecting the complete filling of the reservoir for receiving the water to be filtered, in order, as a result, to increase the count of the useful life of the filter cartridge.

The counting device 11 comprises, on the lid 3, a display means 15 for the count made, electrically connected to the sensor 12.

As shown in FIG. 2, the passage of the flow of water going into the jug 1 through the aperture 4 effects the pivoting of the blocking device 5 from the first, closed position to the second, open position. The relative distance between the magnet 13 and the detecting magnet 14 actuates the counting device 11, increasing (or decreasing) by one unit the number indicated by the display means 15.

The interruption of the passage of the flow of water results in the return of the blocking mechanism 5 from the open position to the closed position by the action of the return effected by the helical spring 9 or by the counterweight 10.

With reference to the example of FIGS. 3 and 4, the sensor 12 comprises a magnet 16, fixed on the opposite end of the arm 8 from the hinge 6, and a magnetic detector 17 fixed in a corresponding position on the lid 3. The magnet 13 and the magnetic detector 14 are close together when the mechanical blocking means 5 is in the open position.

The counting device 11 comprises, on the lid 3, a display means 18 for the count made, electrically connected to the magnetic detector 17.

In a constructional variant of the invention (not shown) the magnetic detector 17 is situated on the arm 8, while the magnet 16 is situated on the lid 3, in a corresponding position.

As shown in FIG. 4, the passage of the flow of water going into the jug 1 through the aperture 4 effects the pivoting of the blocking device 5 from the first, closed position to the second, open position. The relative proximity of the magnet 16 to the magnetic detector 17, in the closed position, actuates the counting device 11, increasing by one unit the number indicated by the display means 18.

The interruption of the passage of the flow of water results in the passage of the blocking mechanism 5 from the open position to the closed position by the effect of the return action of the counterweight 10.

The invention thus solves the problem posed, obtaining the advantage of counting the filtering cycles, in order to determine the exhaustion of the cartridge, automatically, by the action of the water introduced into the jug, without requiring any manual intervention by the user other than that of placing the jug beneath the open tap.

1. A jug for filtering liquids, comprising:
a lid,
an aperture provided through said lid for the filling of the jug,
a blocking mechanism mounted on the lid at the aperture and displaceable between a first position, in which the blocking mechanism closes said aperture, and a second, open position,
actuating means associated with said blocking mechanism for urging it into said first position and allowing its passage into the second position under the action of flow of liquid admitted into the jug through the aperture, and
a counting device for counting cycles of opening and/or closure of said blocking mechanism resulting from the admission of liquid into said jug.

2. A jug according to claim 1, wherein said blocking mechanism is mounted on said lid so as to pivot between said first and second positions.

3. A jug according to claim 1, wherein said counting device comprises a sensor capable of detecting the passage of said lid from, or to, said first or second position.

4. A jug according to claim 3, wherein the sensor is a proximity sensor.

5. A jug according to claim 3, wherein the sensor is a sensor selected from the group consisting of a sensor with contacts, a sensor with a resistance, and a sensor of the capacitive type.

6. A jug according to claim 3, wherein the sensor comprises a first member fixed on one or the other of said lid and said blocking mechanism and a second member fixed in a corresponding position on the respective other of said lid and said blocking mechanism.

7. A jug according to claim 1, wherein the counting device is associated with a display means for the count made.

8. A jug according to claim 1, further comprising a filter cartridge that is replaceable when exhausted, and wherein the counting device is arranged to signal the exhaustion of the cartridge depending on the cycles of filling of said jug through said aperture.
